(19) United States
(12) Patent Application Publication
(10) Pub. No.: US 2026/0049936 A1
(43) Pub. Date: Feb. 19, 2026

(54) POLYMER MATRIX, POLYMER ELECTROLYTE, ALL-SOLID-STATE BATTERY, AND NONDESTRUCTIVE TESTING METHOD

(71) Applicant: SOUTH CHINA UNIVERSITY OF TECHNOLOGY, Guangzhou (CN)

(72) Inventors: Renzong Hu, Guangzhou (CN); Long Hu, Guangzhou (CN); Yihui Sang, Guangzhou (CN); Min Zhu, Guangzhou (CN)

(21) Appl. No.: 19/367,979

(22) Filed: Oct. 24, 2025

Related U.S. Application Data
(63) Continuation-in-part of application No. PCT/CN2025/072895, filed on Jan. 17, 2025.

(30) Foreign Application Priority Data
Aug. 7, 2024 (CN) 202411078012.6

(51) Int. Cl. G01N 21/64; H01M 10/0565

(52) U.S. Cl. CPC G01N 21/6458; H01M 10/0565; H01M 2300/0082

(57) ABSTRACT

Disclosed is a polymer matrix with both excellent electrochemical performance and fluorescence characteristics, which is obtained by labeling an end group of polyethylene oxide with a fluorescent molecule. By modifying the end group of the polyethylene oxide, crystallinity of the polymer matrix is effectively reduced, and the polymer matrix is endowed with the fluorescence characteristics, thereby providing a novel method for nondestructive testing of an electrolyte. Meanwhile, the polymer matrix of the present application can greatly improve electrochemical performance of a polymer electrolyte and suppress lithium dendrites, thereby enabling the polymer electrolyte to have a wide voltage window. Further disclosed are a polymer electrolyte including the polymer matrix, an all-solid-state battery, and a nondestructive testing method thereof. By applying the fluorescence characteristics of the polymer matrix to battery interface characterization, nondestructive testing of a battery interface is achieved.

### CROSS-REFERENCE TO RELATED APPLICATIONS

The present application is a continuation-in-part application of PCT application No. PCT/CN2025/072895 filed on Jan. 17, 2025, which claims the benefit of Chinese Patent Application No. 202411078012.6 filed on Aug. 7, 2024. The contents of all of the aforementioned applications are incorporated by reference herein in their entirety.

### FIELD OF TECHNOLOGY

The present application belongs to the technical field of batteries, and particularly relates to a polymer matrix, a polymer electrolyte, an all-solid-state battery, and a nondestructive testing method.

### BACKGROUND

With continuous expansion of an application scope of electronic equipment, requirements for endurance life and safety performance of batteries of the electronic equipment have also increased accordingly. Therefore, development of lithium-ion batteries with higher energy density and safety has become increasingly important.

Research and development aimed at improving the safety have several branches in the art, among which solid electrolytes have advantages such as non-flammability, high thermal stability, and good mechanical properties, and it has been proven that the solid electrolytes used to replace liquid electrolyte solutions can effectively solve potential safety hazards of the lithium-ion batteries and increase the energy density. Polyethylene oxide (PEO), with a low cost and good compatibility with metallic lithium, has been deemed as a highly promising polymer electrolyte matrix. However, the PEO has lower ionic conductivity (10⁻⁶ S cm⁻¹) at room temperature and a narrower electrochemical window (<3.9 V vs. Li/Li⁺) for stable operation, thereby limiting its applications in high-voltage cathode materials.

At present, structural modification of polymer matrices can effectively improve the ionic conductivity and electrochemical window of the electrolytes, thereby achieving high-voltage applications. For example, a patent document with Publication No. CN 117976971 A discloses a method for preparing a modified polyolefin oxide-based solid electrolyte, which includes synthesis of the solid electrolyte and a vacuum film-forming process at temperature T. The solid electrolyte includes an epoxy polymer substrate as well as component A and a lithium salt dispersed therein; the component A is a modified hydroxyl-rich organic high-molecular polymer; and 0.5T0≤T0 occurs, where T0 is a melting temperature of the epoxy polymer.

The above prior art can decrease crystallinity of the polyolefin oxide-based solid electrolyte to a certain extent and restrict movement of a polyanion group, thereby improving its cycle performance. However, in a solid-state battery assembled from the electrolyte prepared in the prior art, an interface bonding situation between the solid electrolyte and its adjacent structural layer cannot be nondestructively observed, which is crucial for revealing an interface mechanism of the solid-state battery and optimizing interface performance.

Based on the above current situations, the present application aims to find a novel PEO modification and preparation method, so as to achieve dual-functional applications of the electrolytes in electrochemical performance and interface characterization.

### SUMMARY

In view of the problems in the related art, the present application provides a polymer matrix with both excellent electrochemical performance and fluorescence characteristics to overcome the above technical problems in the related prior art. The present application also discloses a polymer electrolyte including the polymer matrix, an all-solid-state battery, and a nondestructive testing method thereof.

Technical solutions of the present application are achieved as follows.

A polymer matrix with both excellent electrochemical performance and fluorescence characteristics is obtained by labeling an end group of polyethylene oxide (PEO) with a fluorescent molecule.

In the present application, by modifying the end group of the polyethylene oxide, crystallinity of the polymer matrix is effectively reduced, and the polymer matrix is endowed with the fluorescence characteristics, thereby providing a new method for nondestructive testing of an electrolyte and effectively solving the problem of difficult observation of the electrolyte. Meanwhile, the polymer matrix of the present application can greatly improve electrochemical performance of a polymer electrolyte and suppress lithium dendrites, thereby enabling the polymer electrolyte to have a wide voltage window.

Preferably, a method for preparing the fluorescent molecule includes the following steps:
A-1) adding tetrabromospirofluorene and 4-borate-4′,4′-dimethoxytriphenylamine in a mass ratio of (80-120):(330-350) into an organic solvent for thorough mixing, then carrying out a sufficient reaction in an inert gas atmosphere at a temperature of ≥100° C. for at least 2 h, and performing purification to prepare an intermediate product; and
A-2) at an ambient temperature of ≤0° C., adding boron tribromide dropwise into the intermediate product prepared in the step A-1) until a reaction solution is not changed in color, then performing stirring continuously for at least 3 h for a complete reaction, and performing rinsing and drying to prepare the fluorescent molecule.

Preferably, in the step A-1), potassium carbonate and tetrakis(triphenylphosphine) palladium are also added in a mass ratio of (80-120):(10-30), and the potassium carbonate and the tetrakis(triphenylphosphine) palladium mainly have an effect of ensuring an alkaline reaction environment with a pH value of ≥7.

Further preferably, in the step A-1), a mass ratio of the potassium carbonate to the organic solvent is (0.5-1.5):(180-220).

Preferably, in the step A-1), the organic solvent is a mixed solution of toluene, ethanol, and water, and a volume ratio of the toluene to the ethanol to the water is (7-9):(0.5-1.5):(0.5-1.5); and

Preferably, in the step A-1), a mass ratio of the organic solvent to the tetrabromospirofluorene is (180-220):(0.5-1.5).

The inert gas is nitrogen or argon.

Preferably, in the step A-2), the rinsing adopted is alternate rinsing with deionized water and dichloromethane, where a number of times of the alternate rinsing is several times, such as 1 time, 2 times, 3 times, 4 times, 5 times, or more times, etc.

In the above method for preparing the fluorescent molecule, the purification is a conventional method in the art, and the stirring and the drying are also conventional operations in the art, provided that respective purposes can be achieved.

Preferably, in the step A-2), a specific operation of the drying is drying in a vacuum drying oven at ≥55° C. for ≥10 h.

Preferably, a method for preparing the polymer matrix includes the following steps:
B-1) at an ambient temperature of ≤0° C., dissolving the polyethylene oxide (PEO) and pyridine in an organic solvent, adding an appropriate amount of phosphorus tribromide (PBr₃) to carry out a reaction for at least 30 min, and then heating up to be ≥75° C. to continue the reaction for at least 10 h;
B-2) after removing the solvent, adding the fluorescent molecule and potassium hydroxide, and then adding methanol and N,N-dimethyl formamide for full dissolution to carry out a sufficient reaction in an inert gas atmosphere at a temperature of ≥60° C. for at least 10 h; and
B-3) neutralizing a remainder of the potassium hydroxide in a reaction solution, and performing dialysis and removing the solvent to prepare the polymer matrix with both excellent electrochemical performance and fluorescence characteristics.

Preferably, in the step B-1), a mass ratio of the polyethylene oxide to the pyridine to the phosphorus tribromide is (100-150):(100-150):(20-50).

Preferably, in the step B-1), the organic solvent is acetonitrile. Further preferably, in the step B-1), a mass ratio of the acetonitrile to the polyethylene oxide is (35-50):1.

Preferably, in the step B-2), a mass ratio of the polyethylene oxide, the fluorescent molecule, and the potassium hydroxide is (100-150):1:(80-120), and the potassium hydroxide is used to ensure an alkaline reaction environment with a pH of >7.

Preferably, in the step B-2), a volume ratio of the methanol to the N,N-dimethyl formamide is (50-70):(4-8), the methanol is used to dissolve the potassium hydroxide, and the N,N-dimethyl formamide is used to dissolve the fluorescent molecule.

Preferably, in the step B-2), a mass ratio of the methanol to the potassium hydroxide is (20-40):(0.5-1.5).

Preferably, in the step B-2), a mass ratio of the N,N-dimethyl formamide to the fluorescent molecule is (400-600):(0.5-1.5).

The inert gas is nitrogen or argon.

Preferably, in the step B-3), the residual potassium hydroxide in the reaction solution is neutralized by using diluted hydrochloric acid. For example, the diluted hydrochloric acid is added dropwise into the reaction solution to neutralize the residual potassium hydroxide or the reaction solution is added dropwise into the diluted hydrochloric acid to neutralize the residual potassium hydroxide.

In the step B-3) of the present invention, both the dialysis is a conventional method in the art.

In addition, in the step B-3), the removal of the solvent is to obtain the polymer matrix, where methods for removing the solvent may be diverse, provided that the purpose is achieved. For example, most of the solvent may be removed first through other methods such as rotary evaporation, and subsequently, the remaining solvent is removed through drying such as oven drying or vacuum drying, thereby obtaining the polymer matrix with both excellent electrochemical performance and fluorescence characteristics of the present invention.

Preferably, in the step B-3), a specific operation of the drying is drying in a vacuum drying oven at ≥55° C. for ≥10 h.

The present application also discloses a polymer electrolyte, which includes the above polymer matrix with both excellent electrochemical performance and fluorescence characteristics.

A method for preparing the above polymer electrolyte includes the following steps:
C-1) in an inert gas atmosphere, formulating the polymer matrix and a lithium salt in an EO to Li⁺ molar ratio of (12-16):1, and placing the same into an organic solvent for mixing and stirring for at least 12 h; and
C-2) pouring a solution obtained in the step C-1) into a mold, and then placing the same in a vacuum environment for drying at 60-80° C. for 12-24 h to prepare the polymer electrolyte.

Preferably, in the step C-1), the inert gas is nitrogen or argon.

The solid polymer electrolyte prepared by the present application has excellent electrochemical performance, with room-temperature ionic conductivity about 1 order of magnitude higher than that of pure polyethylene oxide, and has a superior electrochemical window and cycle stability, which can be applied to the field of lithium batteries.

In addition, the polymer electrolyte of the present application can emit cyan fluorescence under ultraviolet excitation, so that a bonding situation between the polymer electrolyte and an adjacent structural layer can be observed under a microscope in a fluorescence mode.

The solid polymer electrolyte of the present application has a dual-functional application value in the fields of lithium battery applications and nondestructive interface characterization, and provides a new technical solution for related art through a combination of its ionic conductivity and the fluorescence characteristics, thus having a certain practical application value.

Preferably, the lithium salt is lithium bis(trifluoromethanesulfonyl)imide.

In the step C-1) of the present invention, the organic solvent is only used to dissolve the polymer matrix, thus being not limited in use amount and type. However, preferably, in the step C-1), the organic solvent is acetonitrile. Further preferably, a mass ratio of the acetonitrile to the polymer matrix is (10-20):1.

The present application also discloses an all-solid-state battery, which includes a solid polymer electrolyte prepared from the above polymer matrix.

Due to good compatibility between lithium and PEO, preferably, the all-solid-state battery is an all-solid-state lithium metal battery, and the all-solid-state lithium metal battery includes the above polymer electrolyte, a cathode sheet, and a lithium anode sheet, where the cathode sheet and the lithium anode sheet may be prepared by conventional methods in the art

Preferably, a method for preparing the cathode sheet includes the following steps:
S1. weighing a cathode material, polyvinylidene fluoride, and a carbon black conductive agent in a mass ratio of (7.5-8.5):(0.5-1.5):(0.5-1.5), and performing grinding and mixing;
S2. adding an appropriate amount of a solvent into a ground mixture in the S1, and performing grinding continuously until a uniform electrode slurry is formed;
S3. evenly coating the electrode slurry in the S2 onto carbon-coated aluminum foil to form a uniform electrode coating, and performing vacuum drying treatment at a temperature of 60-80° C. for 12-24 h; and
S4. punching a dried sheet material in the S3 to prepare the cathode sheet.

Preferably, the cathode material is LiFePO₄.

Preferably, in the step S2, the solvent is N-methyl pyrrolidone, and further preferably, a mass ratio of the N-methyl pyrrolidone to the cathode material is (3.5-4.5):1.

In the present invention, an amount of the electrode slurry coated onto the carbon-coated aluminum foil in the step S3 is a conventional amount in the art, and a size of the cathode sheet obtained by the punching in step S4 may be customized according to specific use requirements.

The present application also discloses a nondestructive testing method applicable to an all-solid-state battery, where the all-solid-state battery includes a solid electrolyte prepared from the above polymer matrix or the above polymer electrolyte; and
the all-solid-state battery is placed under a microscope in a fluorescence mode for imaging observation to check whether a solid-solid interface has a black gap, thereby determining a tight bonding degree or an interface change situation between the solid polymer electrolyte and an adjacent structural layer (generally an electrode).

The present application is based on the self-developed polymer electrolyte with the fluorescence characteristics. By applying the fluorescence characteristics to battery interface characterization, nondestructive testing of a battery interface is achieved, an application scope of the solid electrolyte is expanded, and a fluorescence characterization method can be applied to battery interface testing.

### BRIEF DESCRIPTION OF THE DRAWINGS

FIG. 1 shows X-ray diffraction patterns of a polymer matrix “PEO-Spiro” prepared in Example 1 and unmodified PEO;

FIG. 2 shows diagrams of states of a polymer electrolyte prepared in the present application before and after ultraviolet irradiation;

FIG. 3 shows bright field images of batteries assembled with a polymer electrolyte prepared in the present application under a microscope;

FIG. 4 shows fluorescence images of the batteries assembled with the polymer electrolyte prepared in the present application under the microscope in an ultraviolet mode;

FIG. 5 is a diagram that shows room-temperature lithium ionic conductivities of electrolyte membranes in Examples 1-4 and Comparative Example 1;

FIG. 6 is a diagram that shows a linear sweep voltammetry curve of a test battery prepared in Example 2;

FIG. 7 is a diagram that shows cycle performance of lithium symmetric batteries prepared from electrolyte membranes in Example 2 and Comparative Example 1;

FIG. 8 is a diagram that shows a current rate cycle curve of the lithium symmetric battery prepared from the polymer electrolyte membrane in Example 2;

FIG. 9 is a diagram that shows a current rate cycle curve of the lithium symmetric battery prepared from the electrolyte membrane in Comparative Example 1; and

FIG. 10 is a diagram that shows charge-discharge cycle performance of all-solid-state lithium metal batteries prepared from electrolyte membranes in Example 5 and Comparative Example 2.

### DESCRIPTION OF THE EMBODIMENTS

The technical solutions in the embodiments of the present application are clearly and completely described below in conjunction with the drawings attached to the embodiments of the present application. Obviously, the described embodiments are only a part of the embodiments of the present application, rather than all of the embodiments. Based on the embodiments of the present application, all other embodiments obtained by those of ordinary skill in the art without creative effort shall fall within the protection scope of the present application.

### Example 1

A. A method for preparing a fluorescent molecule Spiro-TPA-08 is as follows.

A-1) 100 mg of tetrabromospirofluorene (C₂₅H₁₂Br₄), 341 mg of 4-borate-4′,4′-dimethoxytriphenylamine (C₂₆H₃₀BNO₄), 110 mg of K₂CO₃, and 20 mg of tetrakis(triphenylphosphine) palladium were sequentially added into 25 ml of a mixed solution of toluene, ethanol, and water (a volume ratio of the toluene to the ethanol to the water was 8:1:1), and then a sufficient reaction was carried out in an inert gas (nitrogen) atmosphere at 120° C. for 3 h; and
a resulting product was purified by column chromatography to remove incompletely unreacted reactants and an insufficiently reacted product to obtain an intermediate product “Spiro-TPA-OCH₃”.

A-2) Under ice water bath conditions, boron tribromide was added dropwise into the purified product Spiro-TPA-OCH₃ until a reaction solution was not changed in color, and then stirring was performed continuously for 4 h to carry out a reaction completely; and after the reaction was completed, the reaction solution was subjected to alternate rinsing with deionized water and dichloromethane for 6 times and placed in a vacuum drying oven for drying at 60° C. for 12 h to obtain a fluorescent molecule product “Spiro-TPA-08”.

B. A method for preparing a polymer matrix PEO-Spiro with fluorescence characteristics is as follows.

B-1) 1.2 g of PEO and 1 ml of pyridine were dissolved in 60 ml of an acetonitrile solvent for complete dissolution in an ice water bath, then 0.2 ml of PBr₃ was added to carry out a reaction for 30 min, and heating up to 80° C. to continue the reaction for 12 h.

B-2) After a surplus of the solvent was removed from a reaction solution using a rotary evaporator, 10 mg of the Spiro-TPA-08, 0.8 g of KOH, 60 ml of methanol, and 5 ml of N,N-dimethyl formamide were added for uniform mixing, and then allowed to undergo a reaction in an inert gas (nitrogen) atmosphere at 70° C. for 12 h.

B-3) A reaction solution was dropped into diluted hydrochloric acid with a concentration of 2 mol/L to neutralize a remainder of the KOH, subjected to dialysis in deionized water for 3 days and rotary evaporation to remove most of the solvent, and then placed in a vacuum drying oven for drying at 60° C. for 12 h to obtain a polymer matrix “PEO-Spiro”.

C. Preparation of a polymer electrolyte

C-1) In an argon environment, 1 g of the PEO-Spiro and a corresponding mass of lithium bis(trifluoromethanesulfonyl)imide (LiTFSI) as a lithium salt were separately weighed in an EO to Li⁺ molar ratio of 12:1, placed into 20 ml of an acetonitrile solvent, and stirred continuously for mixing for a stirring time of 18 h.

C-2) A solution was poured into a polytetrafluoroethylene mold, and then placed in a vacuum environment for drying at 60° C. for 12 h to prepare a polymer electrolyte membrane “PEO-Spiro-LiTFSI”.

### Example 2

Compared with Example 1, 1 g of PEO-Spiro and a corresponding mass of LiTFSI as a lithium salt were separately weighed in an EO to Li⁺ molar ratio of 13:1 in the present example.

### Example 3

Compared with Example 1, 1 g of PEO-Spiro and a corresponding mass of LiTFSI as a lithium salt were separately weighed in an EO to Li⁺ molar ratio of 14:1 in the present example.

### Example 4

Compared with Example 1, 1 g of PEO-Spiro and a corresponding mass of LiTFSI as a lithium salt were separately weighed in an EO to Li⁺ molar ratio of 16:1 in the present example.

### Example 5

An all-solid-state lithium metal battery is provided.

D) A method for preparing a cathode sheet in the present example is as follows.

D-1) 0.4 g of lithium iron phosphate (LiFePO₄), 0.05 g of polyvinylidene fluoride (PVDF), and 0.05 g of a carbon black conductive agent (Super P) were uniformly mixed in a mass ratio of 8:1:1 and then placed in a mortar for manual grinding for a manual grinding time of 30 min, 1.5 g of N-methyl pyrrolidone (NMP) was added to form a slurry after the grinding, and manual grinding was performed continuously for 30 min to prepare an electrode slurry; and
the electrode slurry was coated onto carbon-coated aluminum foil to prepare an electrode sheet, and then the electrode sheet was transferred into a vacuum drying oven for drying under vacuum at 80° C. for 12 h and punched into a disc with a diameter of 12 mm to prepare a cathode sheet.

D-2) A polymer electrolyte membrane prepared in Example 2 was cut into a 12 mm disc, and then assembled with the cathode sheet and a lithium metal to prepare a LiFePO₄|PEO-Spiro|Li all-solid-state lithium metal battery.

### Comparative Example 1

Compared with Example 4, in the present comparative example, the polymer matrix was PEO without end group modification, and the PEO and a corresponding mass of lithium bis(trifluoromethanesulfonyl)imide (LiTFSI) as a lithium salt were mixed in an EO to Li⁺ molar ratio of 16:1 to prepare an electrolyte membrane “PEO-LiTFSI”.

### Comparative Example 2

Compared with Example 5, in the present comparative example, the electrolyte membrane prepared in Comparative Example 1 was used to prepare a LiFePO₄|PEO|Li battery.

### Performance Tests

### 1. X-Ray Diffraction Analysis

Unmodified PEO and polymer matrices “PEO-Spiro” prepared in Examples 1-4 were subjected to X-ray diffraction analysis and comparison to obtain results with Example 1 as an example. As shown in FIG. 1, diffraction peaks of the PEO-Spiro are consistent with those of the PEO, indicating that an overall long-chain structure of the modified PEO-Spiro still remains consistent with the PEO, only different in that functional groups at two ends are replaced.

### 2. Fluorescence Characteristic Test

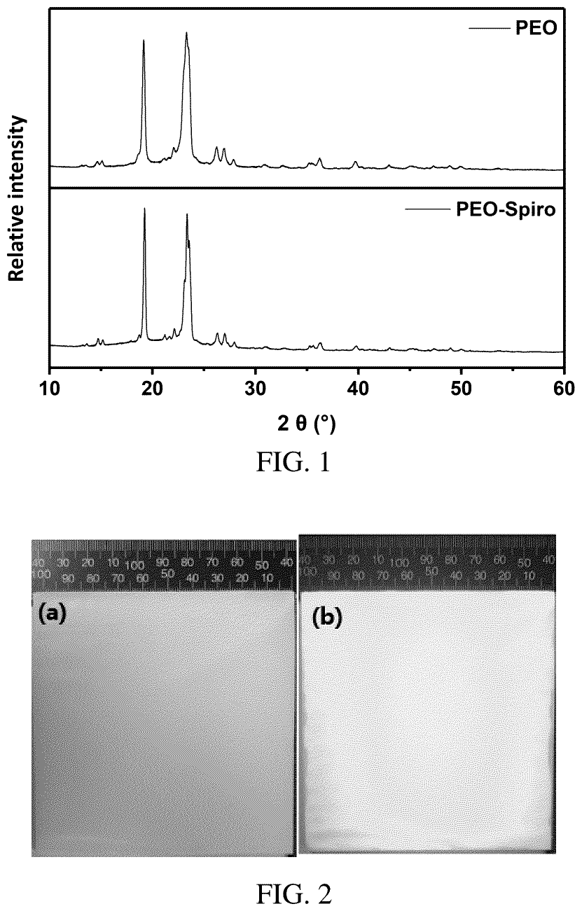

Picture (a) in FIG. 2 shows a physical image of polymer electrolyte membranes “PEO-Spiro-LiTFSI” prepared in Examples 1-4. Ultraviolet irradiation results are shown in picture (b) of FIG. 2. It can be seen that the polymer electrolyte membranes “PEO-Spiro-LiTFSI” prepared in the present application exhibit a fluorescence phenomenon under the ultraviolet irradiation. In practical visual observation, the polymer electrolyte membranes are changed from light green to cyan, clearly indicating that the polymer electrolyte membranes “PEO-Spiro-LiTFSI” prepared in the present application have fluorescence characteristics and can exhibit a fluorescence phenomenon under ultraviolet excitation.

### 3. Study on a Nondestructive Testing Method Based on the Fluorescence Characteristics

In an Ar glove box, the polymer electrolyte membrane “PEO-Spiro-LiTFSI” prepared in Example 2 was cut into a 16 mm disc, and then the disc was placed between two lithium sheets to prepare a lithium symmetric battery (“sample A”) with poor solid-solid interface contact and a lithium symmetric battery (“sample B”) with tight solid-solid interface contact by applying different pressing pressures, respectively.

3-1) The above two samples were placed under a microscope in a bright field image mode for imaging observation.

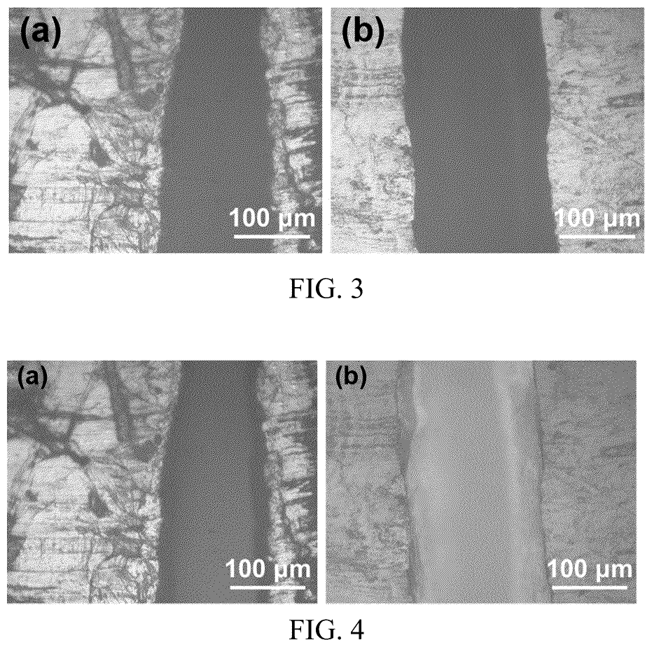

Results are shown in FIG. 3. Two sides in FIG. 3 are lithium metals, and a black part in the middle is the polymer electrolyte membrane “PEO-Spiro-LiTFSI”. The results indicate that under bright field images of an optical microscope, contact degrees between the polymer electrolyte membrane and an electrode in the two samples cannot be determined.

3-2) The above two assembled lithium symmetric batteries were placed under a microscope in a fluorescence mode for imaging observation.

Results are shown in FIG. 4. FIG. 4 shows fluorescence bright field images of the above two samples under ultraviolet excitation. From a fluorescence optical image (a), it can be clearly seen that a black gap part is at an interface between the lithium electrode and the polymer electrolyte membrane of the “sample A” with poor solid-solid interface contact. From a fluorescence optical image (b), it can be seen that no obvious black gap part appears at an interface between the lithium electrode and the polymer electrolyte membrane of the “sample B” with tight solid-solid interface contact.

In summary, for a battery product sandwiched with the polymer electrolyte membrane “PEO-Spiro-LiTFSI” of the present application, the product can be subjected to ultraviolet irradiation under a microscope in a fluorescence mode, and determining a tight bonding degree between the polymer electrolyte membrane and an electrode based on whether a black gap appears at a solid-solid interface or observing an interface change situation is a nondestructive testing method.

### 4. Room-Temperature Ionic Conductivity Test

In an Ar glove box, the polymer electrolyte membranes “PEO-Spiro-LiTFSI” prepared in Examples 1-4 and the electrolyte membrane “PEO-LiTFSI” prepared in Comparative Example 1 were cut into 10 mm discs and then the discs were placed between two stainless steel sheets to form blocking electrodes as test samples.

An alternating-current impedance test was carried out on the test samples at an electrochemical workstation within a frequency range from a high frequency to a low frequency of 1 MHz to 0.1 Hz to obtain room-temperature ionic conductivity of the test samples.

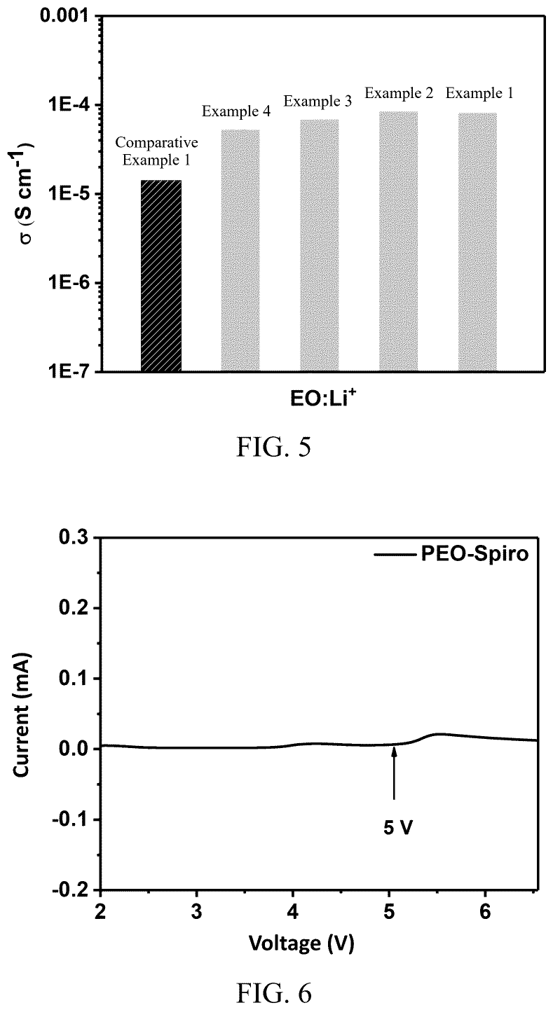

Test results are shown in FIG. 5. The room-temperature ionic conductivity of the electrolyte membrane in Comparative Example 1 is lower than that in Examples 1-4. That is, the “PEO-Spiro” with end group modification in the present application not only enables the polymer electrolyte membranes to have fluorescence characteristics, but also improves the room-temperature ionic conductivity of the PEO polymer electrolyte membranes, thereby enhancing electrochemical performance. On the other hand, it can be seen from FIG. 5 that the polymer electrolyte membrane prepared by formulating the lithium salt with an addition amount in the EO to Li⁺ molar ratio of 13:1 exhibits the best room-temperature ionic conductivity performance.

### 5. Electrochemical Window Test

In an Ar glove box, the polymer electrolyte membrane “PEO-Spiro-LiTFSI” prepared in Example 2 was cut into a 10 mm disc, and the disc was placed between a stainless steel sheet and a lithium sheet to assemble a battery, and then a linear sweep voltammetry curve test was carried out on the battery using an electrochemical workstation within a test potential range of 0 V-6.55 V at a sweep rate of 1 mV/s.

Results are shown in FIG. 6. The polymer electrolyte membrane “PEO-Spiro-LiTFSI” prepared in Example 2 has an electrochemical window of 5 V or above, indicating that the “PEO-Spiro” with end group modification in the present application effectively improves the electrochemical window of the polymer electrolyte membrane.

### 6. Cycle Performance Test

In an Ar glove box, both the polymer electrolyte membrane “PEO-Spiro-LiTFSI” prepared in Example 2 and the electrolyte membrane “PEO-LiTFSI” prepared in Comparative Example 1 were cut into 16 mm discs, and then the discs were placed between two lithium sheets to prepare lithium symmetric batteries, respectively.

A cycle performance test was carried out in a Land test system at a current density of 0.1 mA/cm², with an alternating charge-discharge process performed once every half hour during the test.

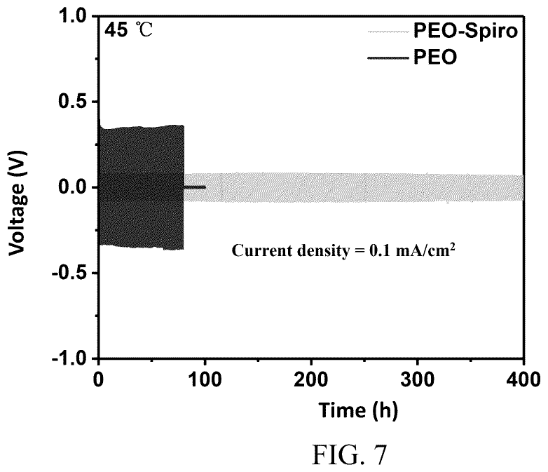

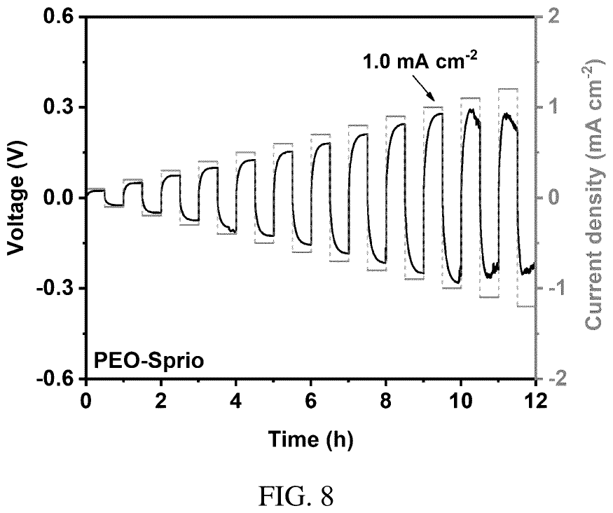

Results are shown in FIG. 7. The lithium symmetric battery prepared using the polymer electrolyte membrane in Example 2 can still remain stable without a short circuit when cycling at 400 h, and the lithium symmetric battery prepared using the electrolyte membrane in Comparative Example 1 has a short circuit as shown in the figure, indicating that the “PEO-Spiro” with end group modification in the present application effectively improves the cycle performance of the polymer electrolyte membrane.

### 7. Limiting Current Density Test

In an Ar glove box, both the polymer electrolyte membrane “PEO-Spiro-LiTFSI” prepared in Example 2 and the electrolyte membrane “PEO-LiTFSI” prepared in Comparative Example 1 were cut into 16 mm discs, and then the discs were placed between two lithium sheets to prepare lithium symmetric batteries, respectively.

A limiting current density test was carried out in a Land test system.

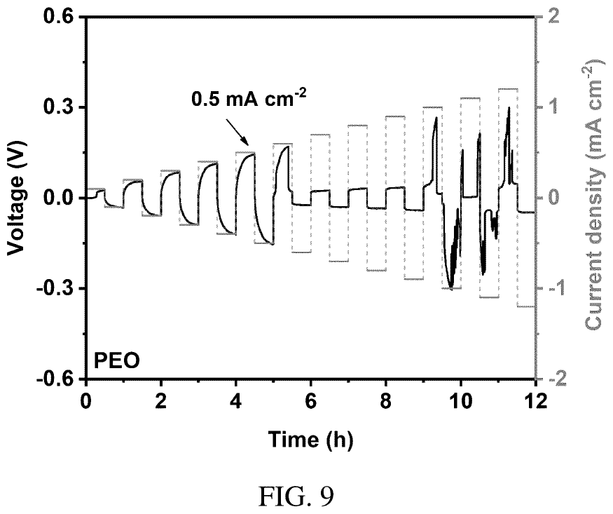

FIG. 8 shows a diagram of cycle performance of the lithium symmetric battery prepared in Example 2 at different current densities, and FIG. 9 shows a diagram of cycle performance of the lithium symmetric battery prepared in Comparative Example 1 at different current densities. From FIG. 8 and FIG. 9, it can be seen that the polymer electrolyte membrane prepared in Example 2 has a limiting current density of 1.0 mA/cm², while the electrolyte membrane in Comparative Example 1 only has a limiting current density of 0.5 mA/cm² and stable cycling of not greater than 100 h, which is greatly different from that in Example 2, indicating that the PEO-Spiro with end group modification in the present application can effectively increase the limiting current density of the polymer electrolyte membrane.

8. Cycle Performance Test of all-Solid-State Lithium Metal Batteries

At 45° C. and 0.2 C, a cycle performance test was carried out on the all-solid-state lithium metal batteries prepared in Example 5 and Comparative Example 2.

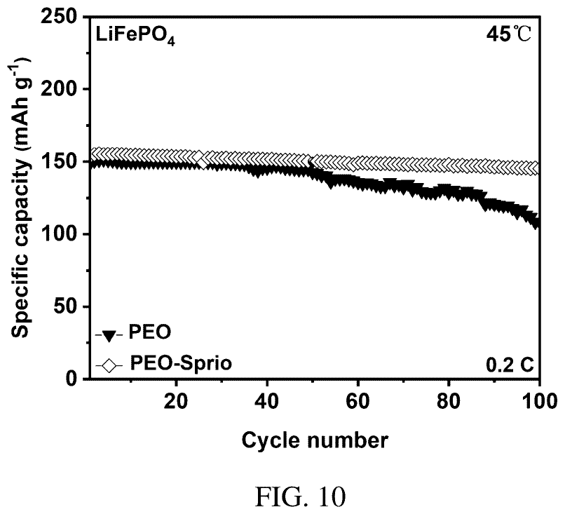

Results are shown in FIG. 10. It can be seen from the figure that the LiFePO₄|PEO-Spiro|Li all-solid-state lithium metal battery prepared in Example 5 has a discharge specific capacity of 145.2 mAh g⁻¹ and a capacity retention rate of 94.6% after cycling for 100 cycles; and the LiFePO₄|PEO|Li battery prepared in Comparative Example 2 has a discharge specific capacity of 108.3 mAh g⁻¹ and a capacity retention rate of 71.6% after cycling for 100 cycles.

By comparing the performance of the polymer PEO before and after end group modification in the above examples and comparative examples, effectiveness of the present application in improving the electrical performance of a PEO-based polymer electrolyte and pioneering application of a fluorescence interface characterization method in the field of lithium batteries are proven.

According to the disclosure and teaching of the above specification, those skilled in the art to which the present application belongs may also make alterations and modifications to the above embodiments. Therefore, the present application is not limited to the specific embodiments disclosed and described above, and some modifications and alterations to the present application should also fall within the protection scope of the claims of the present application. In addition, although some specific terms are used in the specification, these terms are for convenience of description only and do not impose any limitation on the present application.

What is claimed is:

1. A polymer matrix with both excellent electrochemical performance and fluorescence characteristics, obtained by labeling an end group of polyethylene oxide with a fluorescent molecule.

2. The polymer matrix with both excellent electrochemical performance and fluorescence characteristics according to claim 1, wherein a method for preparing the fluorescent molecule comprises the following steps:
A-1) adding tetrabromospirofluorene and 4-borate-4′,4′-dimethoxytriphenylamine in a mass ratio of (80-120):(330-350) into an organic solvent for thorough mixing, then carrying out a sufficient reaction in an inert gas atmosphere at a temperature of ≥100° C. for at least 2 h, and performing purification to prepare an intermediate product; and
A-2) at an ambient temperature of ≤0° C., adding boron tribromide dropwise into the intermediate product prepared in the step A-1) until a reaction solution is not changed in color, then performing stirring continuously for at least 3 h for a complete reaction, and performing rinsing and drying to prepare the fluorescent molecule.

3. The polymer matrix with both excellent electrochemical performance and fluorescence characteristics according to claim 1, wherein a method for preparing the polymer matrix comprises the following steps:
B-1) at an ambient temperature of ≤0° C., dissolving the polyethylene oxide and pyridine in an organic solvent, adding an appropriate amount of phosphorus tribromide to carry out a reaction for at least 30 min, and then heating up to be ≥75° C. to continue the reaction for at least 10 h;
B-2) after removing a surplus of the solvent, adding the fluorescent molecule and potassium hydroxide, and then carrying out a sufficient reaction in an inert gas atmosphere at a temperature of ≥60° C. for at least 10 h; and
B-3) neutralizing a remainder of the potassium hydroxide in a reaction solution, performing dialysis to remove the solvent to prepare the polymer matrix with both excellent electrochemical performance and fluorescence characteristics.

4. The polymer matrix with both excellent electrochemical performance and fluorescence characteristics according to claim 2, wherein a method for preparing the polymer matrix comprises the following steps:
B-1) at an ambient temperature of ≤0° C., dissolving the polyethylene oxide and pyridine in an organic solvent, adding an appropriate amount of phosphorus tribromide to carry out a reaction for at least 30 min, and then heating up to be ≥75° C. to continue the reaction for at least 10 h;
B-2) after removing a surplus of the solvent, adding the fluorescent molecule and potassium hydroxide, and then carrying out a sufficient reaction in an inert gas atmosphere at a temperature of ≥60° C. for at least 10 h; and
B-3) neutralizing a remainder of the potassium hydroxide in a reaction solution, performing dialysis to remove the solvent to prepare the polymer matrix with both excellent electrochemical performance and fluorescence characteristics.

5. The polymer matrix with both excellent electrochemical performance and fluorescence characteristics according to claim 3, wherein in the step B-1), a mass ratio of the polyethylene oxide, the pyridine, and the phosphorus tribromide is (100-150):(100-150):(20-50).

6. The polymer matrix with both excellent electrochemical performance and fluorescence characteristics according to claim 4, wherein in the step B-1), a mass ratio of the polyethylene oxide, the pyridine, and the phosphorus tribromide is (100-150):(100-150):(20-50).

7. The polymer matrix with both excellent electrochemical performance and fluorescence characteristics according to claim 3, wherein in the step B-2), a mass ratio of the polyethylene oxide to the fluorescent molecule is (100-150):1.

8. The polymer matrix with both excellent electrochemical performance and fluorescence characteristics according to claim 4, wherein in the step B-2), a mass ratio of the polyethylene oxide to the fluorescent molecule is (100-150):1.

9. A polymer electrolyte, comprising the polymer matrix according to claim 1.

10. A polymer electrolyte, comprising the polymer matrix according to claim 2.

11. A polymer electrolyte, comprising the polymer matrix according to claim 3.

12. The polymer electrolyte according to claim 9, wherein a method for preparing the polymer electrolyte comprises the following steps:
C-1) in an inert gas atmosphere, formulating the polymer matrix and a lithium salt in an EO to Li⁺ molar ratio of (12-16):1, and placing the same into an organic solvent for mixing and stirring for at least 12 h; and
C-2) pouring a solution obtained in the step C-1) into a mold, and then placing the same in a vacuum environment for drying at 60-80° C. for 12-24 h to prepare the polymer electrolyte.

13. An all-solid-state battery, comprising a solid electrolyte prepared from the polymer matrix according to claim 1.

14. An all-solid-state battery, comprising a solid electrolyte prepared from the polymer matrix according to claim 2.

15. An all-solid-state battery, comprising a solid electrolyte prepared from the polymer matrix according to claim 3.

16. The all-solid-state battery according to claim 8, wherein the all-solid-state battery is an all-solid-state lithium metal battery, and the all-solid-state lithium metal battery comprises the above polymer electrolyte, a cathode sheet, and a lithium anode sheet.

17. A nondestructive testing method applicable to an all-solid-state battery, wherein the all-solid-state battery comprises a solid electrolyte prepared from the polymer matrix according to claim 1; and
the all-solid-state battery is placed under a microscope in a fluorescence mode for imaging observation to check whether a solid-solid interface has a black gap, thereby determining a tight bonding degree or an interface change situation between the solid polymer electrolyte and an adjacent structural layer.

18. A nondestructive testing method applicable to an all-solid-state battery, wherein the all-solid-state battery comprises a solid electrolyte prepared from the polymer matrix according to claim 2; and
the all-solid-state battery is placed under a microscope in a fluorescence mode for imaging observation to check whether a solid-solid interface has a black gap, thereby determining a tight bonding degree or an interface change situation between the solid polymer electrolyte and an adjacent structural layer.

19. A nondestructive testing method applicable to an all-solid-state battery, wherein the all-solid-state battery comprises a solid electrolyte prepared from the polymer matrix according to claim 3; and
the all-solid-state battery is placed under a microscope in a fluorescence mode for imaging observation to check whether a solid-solid interface has a black gap, thereby determining a tight bonding degree or an interface change situation between the solid polymer electrolyte and an adjacent structural layer.

20. A nondestructive testing method applicable to an all-solid-state battery, wherein the all-solid-state battery comprises a solid electrolyte prepared from the polymer matrix according to claim 4; and
the all-solid-state battery is placed under a microscope in a fluorescence mode for imaging observation to check whether a solid-solid interface has a black gap, thereby determining a tight bonding degree or an interface change situation between the solid polymer electrolyte and an adjacent structural layer.
